(19) United States
(12) Patent Application Publication
(10) Pub. No.: US 2021/0109294 A1
(43) Pub. Date: Apr. 15, 2021

(54) ILLUMINATING RECEPTACLE AND METHOD

(71) Applicant: Xieon Networks S.a.r.l., Luxemburg (LU)

(72) Inventors: Carlo Miguel Fernandes MARQUES, Lisboa (PT); Carlos António Lopes ANTUNES, Loures (PT); Paola FRASCELLA, Parede (PT)

(21) Appl. No.: 16/598,908

(22) Filed: Oct. 10, 2019

(51) Int. Cl. G02B 6/38

(52) U.S. Cl. CPC G02B 6/3825; G02B 6/3849; G02B 6/3869; G02B 6/3874; G02B 6/3893

(57) ABSTRACT

The disclosed receptacle and method of the present invention enables light, such as port status/operation indicator light for example, to pass through at least a portion of the receptacle, and in turn illuminate at least a portion of the receptacle. In one example application or embodiment the light that so illuminates the receptacle originates from a light source that is external to the receptacle, while in another example application or embodiment the light originates from a light source within the receptacle.

### BACKGROUND

The invention relates in general to the field of receptacles, such as for example receptacles adapted to receive a connector for a communication cable. In the area of optical communication equipment, for example, such receptacles can include for example and without limitation optical fiber adapters, or pluggable optical transponders or transceivers, or other receptacles that serve to receive a connector to optically couple the end of a first optical fiber cable to another optical path or component, such as for example a second optical fiber cable or other optical device.

In the example of optical fiber adapters, optical fiber adapters of the prior art for example can be a rectangular device wherein a first end of the adapter serves to removably receive an optical fiber connector, including a first optical fiber cable end ferrule, or a first pair of ferrules such as can be the case for example with a LC or SC connector, while a second opposing end of the adapter may serve to receive another optical fiber connector including a second ferrule, or pair of ferrules, associated with one or more other optical fiber cable ends that is/are to be optically coupled with the optical fiber cable end(s) associated with the first ferrule or ferrule pair. In this way, this example prior art adapter receives into a first end of the adapter at least one connector including one or more ferrules and respectively aligns, along a common axis within the adapter, each respective optical fiber end with a corresponding optical fiber end received into the adapter from the opposing end of the adapter. Accordingly, such a prior art adapter serves to facilitate an optical coupling for the communication of one or more optical communication signals between one optical fiber cable or cable pair and another optical fiber cable or cable pair.

Other forms of known receptacles include by way of example other configurations of optical adapters and electrical adapters, as well as receptacles that receive an optical or electrical communication cable connector so as to operatively couple the communication cable with a device other than another communication cable, in a way that facilitates optical or electrical communication therebetween.

Communication system modules or cards of the prior art for example have incorporated adapters such as these within their front panels or faceplates. In the example of an optical communication system module, when such a module is placed within a shelf of a communication system, such adapters serve to establish the locations of optical ports of the optical communication system to which communication system operators can, from a system operator side of the module front panel or faceplate, removably couple one or more optical fibers using one or more optical fiber connectors. Such modules of the prior art sometimes further provide a separate indicator, such as a light-emitting diode (LED) indication, located on the module panel for example to indicate to a system operator one or more mode(s), state(s), status, and/or other operational characteristic(s) of a given communication port or ports, including for example at a location on the panel that is at least near, if not immediately next to, the adapter that corresponds to the port(s) to which the indicator relates.

FIG. 1 illustrates a representative example prior art placement of LED indicators 10-28 near respective optical adapters 30-48 on the front panel or faceplate 60 of optical communication system module 70. An optical adapter type of the sort shown on module 70 however is but just one example of prior art receptacles.

While many of the above examples are drawn from the field of optical communications, it will be understood that similar approaches as those described above have also been used with respect to adapters and other forms of receptacles that support electrical ports or connections. It is known for example that many personal computers include a RJ-45 jack to interface with a RJ-45 connector of an Ethernet network cable, and that many of such computers use one or more LED indicators located on or immediately adjacent the RJ-45 jack to provide information relating to the Ethernet connection/communications supported by the jack.

### SUMMARY

In addition to enabling the coupling of for example one or more communication cable(s), connector(s), and/or other path(s) and/or device(s), through which for example optical or electrical network communication traffic communicates in conventional manners known to those skilled in the art, the apparatus and methods of the present invention further enables light, such as indicator light for example, to pass through at least a portion of the structure of the apparatus itself such that the communicated light in turn illuminates, or emits, from a surface of the apparatus, preferably to provide one or more indications regarding the status and/or operation of the associated connection or communication equipment.

In a preferred example application of the present invention, the light that communicates through the receptacle itself is indicator light representing, for the benefit of an installer, test engineer, or system operator, one or more mode(s), state(s), status, and/or other operational characteristic(s) of the port(s) or connection(s) associated with the receptacle, or the module or other communication system device within which the receptacle is placed or is located, or more generally the communication system to which the module or device belongs. In one such example application, such indicator light that communicates through a receptacle body portion originates from a light source that is external to the receptacle, while in another example application such indicator light originates from a light source within the receptacle.

As a result, example embodiments of the invention can be used to obviate the need for placement of a separate indicator at another location on a panel or enclosure distinct from the receptacle, such as for example on a portion of the panel or enclosure that is near or next to the receptacle. In this way, the limited surface area that is typically available on a panel of a communication system module, or on the front end of a pluggable device, or on another enclosure surface, for example can be used in a more streamlined, efficient, and/or effective manner, as just one example among the various benefits that those skilled in the art will understand and appreciate can be realized through the present invention.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, so as to more clearly depict and allow emphasis to instead be placed upon various elements of the illustrated example embodiments that are described in further detail below.

FIG. 1 is an example front panel, or faceplate, and a dual-bore/cavity optical fiber connector adapter array of a communication system module of the prior art.

FIG. 2 is an example prior art dual-bore/cavity optical fiber connector adapter together with two pairs of optical fibers and associated optical fiber connectors that are each respectively received into the adapter so as to optically couple the fiber pairs to one another.

FIG. 3 is an illustration of a dual-bore/cavity optical fiber connector adapter, according to an example embodiment of the present invention.

FIG. 4 is partially exploded view of the optical fiber connector adapter embodiment shown in FIG. 3.

FIG. 5 is the optical fiber connector adapter embodiment shown in FIG. 3, shown together with an example adjacent printed circuit board of the communication system module with which the adapter embodiment may be associated.

FIG. 6 is side elevation view of the optical fiber connector adapter embodiment and example printed circuit board arrangement shown in FIG. 5, further depicted for example as placed within, and more specifically extending partially through, a portion of an example panel of the communication system module.

FIG. 7 is top view of the optical fiber connector adapter embodiment and example printed circuit board arrangement shown in FIGS. 5 and 6.

FIG. 8 is an illustration of an optical fiber connector adapter, according to another example embodiment of the present invention.

FIG. 9 is side elevation view of the optical fiber connector adapter embodiment shown in FIG. 8, depicted for example as placed within, and more specifically extending partially through, a portion of an example panel of a communication system module.

FIG. 10 is top view of the optical fiber connector adapter embodiment shown in FIG. 9.

FIG. 11 is an illustration of a dual-bore/cavity optical fiber connector receptacle, in the example application of a pluggable optical transponder or transceiver device, according to an example embodiment of the present invention.

FIG. 12 is partially exploded view of the optical fiber connector receptacle embodiment shown in FIG. 11.

FIG. 13 is view, from a top front perspective, of the optical fiber connector receptacle embodiment shown in FIGS. 11 and 12.

FIG. 14(a) is front elevation view of the optical fiber connector receptacle embodiment shown in FIGS. 11-13.

FIG. 14(b) is side elevation view of the optical fiber connector receptacle embodiment shown in FIGS. 11-14(a).

FIG. 15 is top view of the optical fiber connector receptacle embodiment shown in FIGS. 11-14.

### DETAILED DESCRIPTION

A description of example embodiments of the invention follows.

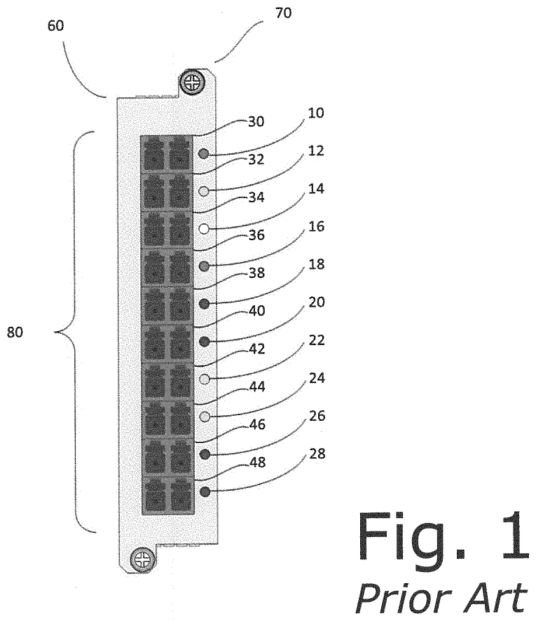

FIG. 1 depicts an example panel 60 and optical fiber connector adapter array 80 of a communication system module 70 of the prior art. Each of the LED-based indicators 10-28 are located on the panel 60 near respective optical adapters 30-48, and in this example illuminate in one or more ways to indicate, for example to an installer, test engineer, or system operator, one or more mode(s), state(s), status, and/or other operational characteristic(s) of a given communication port. For example, indicator 10 can illuminate to provide mode/state/status/operational information about the corresponding port that adapter 30 serves to establish. The same is true for indicator 12, with respect to the corresponding port that adapter 32 serves to establish, and so on.

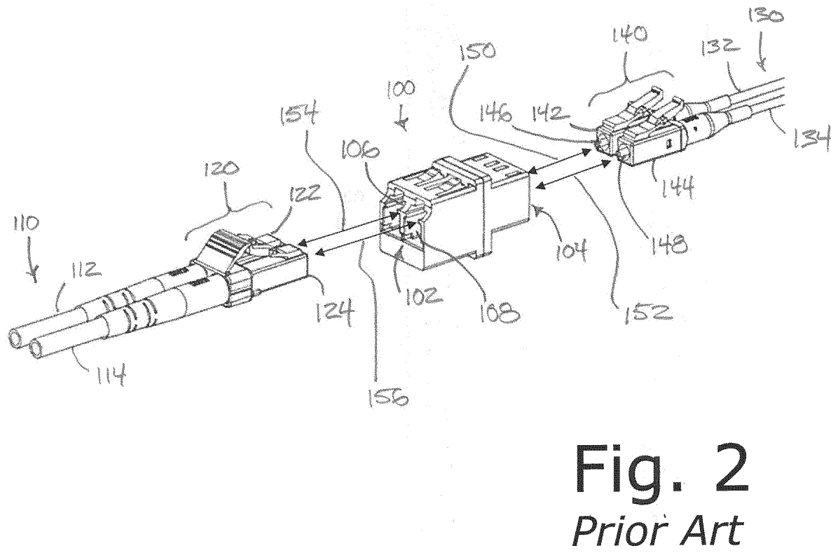

FIG. 2 depicts an example prior art optical fiber adapter 100 together with a first pair of optical fibers 110 and associated optical fiber connectors 120, and a second pair of optical fibers 130 and associated optical fiber connectors 140. Each connector 122 and 124 of the first pair 120 is received into the adapter 100 at a first end 102 of the adapter 100, while each connector 142 and 144 of the second pair 140 is received into the adapter 100 at a second end 104 of the adapter 100. In this example the adapter 100 serves to retain and align the respective connector pairs 120 and 140, and associated ferrules therein, so as to optically couple optical fibers 112 and 132, and optical fibers 114 and 134, respectively. In this regard, while only ferrules 146 and 148 are visible in FIG. 2 given the perspective of the figure, it is understood by those skilled in the art that connector pair 120 in this example contains similarly situated ferrules that are merely obscured from view given the illustrated perspective of connector pair 120. Similarly, the illustrated perspective of adapter 100 in FIG. 2 obscures from view two bores, or cavities, on end 104 that are similar to cavities 106 and 108 visible on adapter end 102. Connectors 142 and 144 are respectively received into the two obscured-from-view cavities in a similar manner as connectors 122 and 124 are respectively received into cavities 106 and 108, as indicated by illustrated arrows 150, 152, 154 and 156. From both a mechanical and optical communication perspective, the example embodiments of the present invention disclosed below serve, at a very fundamental level, to receive and align connectors and ferrules, and in turn optically couple optical fibers, in a similar manner as the prior art example shown in FIG. 2, as will be understood by those skilled in the art.

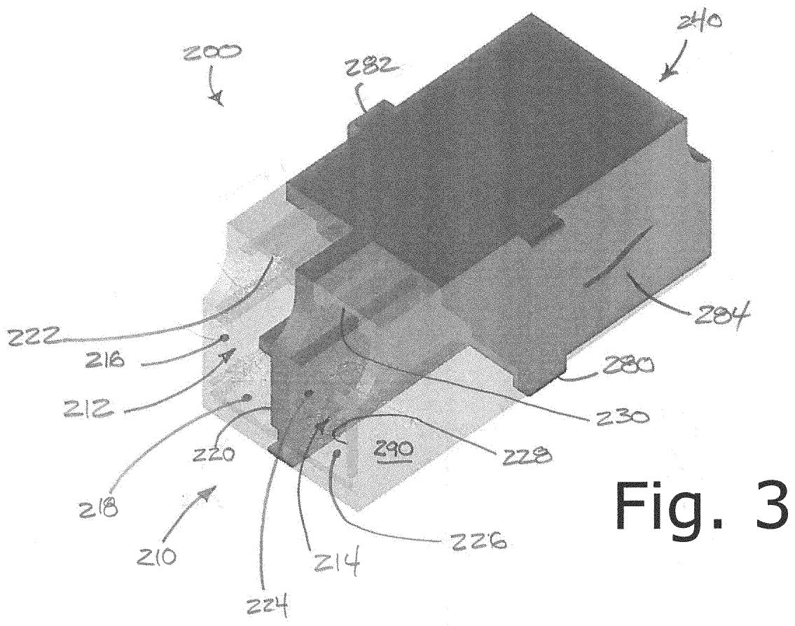

A first example embodiment of the present invention is illustrated schematically beginning with FIG. 3. Receptacle 200 in this particular example is an optical fiber connector adapter 200 that, in a similar conventional manner such as that shown for example by FIG. 2, serves to respectively couple each of up to two optical fiber connectors (not illustrated in FIG. 3), received into the adapter at a first, or in this example also referred to as a front, end 210 of adapter 200, to a corresponding optical fiber connector (also not illustrated in FIG. 3) received into adapter 200 at a second, or in this example also referred to as a back, end 240 of adapter 200. Adapter 200 can serve as a point of interface on for example a front panel of a module of a communication system and, in this way, adapter 200 could be used for example to support both the transmit (Tx) and receive (Rx) subsections of an optical communication port wherein the Tx subsection is associated with a first cavity of the two cavities 212 and 214 while the Rx subsection is associated with the other of the two cavities 212 and 214.

Except for those instances herein where it is otherwise specified, however, generally speaking the term “port” as used herein is not intended to set forth a narrower definition of the term as compared to what is ordinarily understood by those of skill in the art, and thus for example by itself the term “port” as used herein does not describe only applications that are optical, nor is it limited to those applications having a Tx subsection associated with a first cavity and a separate Rx subsection associated with a second cavity, nor is it limited to those applications having both Tx and Rx functionality.

In this regard, in this particular example embodiment an optical fiber connector can be received through one of the two openings in the first end 210 of adapter 200 and into a cavity, such as for example one of cavities 212 and 214. Adapter 200 for example could support an optical communication port wherein cavities 212 and 214 each relate to a respective subsection (either Tx or Rx) of the optical communication port. Each cavity 212 and 214 is defined at least in part by one or more interior walls that extend into the adapter from the opening, such as for example walls 216, 218 and 220 of cavity 212, and at least walls 224, 226 and 228 of cavity 214, and serve at least in part to position a received connector within adapter 200 to facilitate a coupling, in this example an optical coupling, with an optical fiber terminated by the received optical fiber connector. In this example, a given optical fiber connector is received into cavity 212 or 214 through an opening in an exterior surface at the first, or front, end 210 of adapter 200, the opening being formed at least in part by and along the exterior edges of at least walls 216, 218 and 220, in the case of the opening associated with cavity 212, or the exterior edges of at least walls 224, 226 and 228, in the case of the opening associated with cavity 214.

While those skilled in the art will appreciate that different wall form factors than that shown for example in FIG. 3 are also used in the industry to accommodate different connector form factors, one or more interior walls of such adapters nevertheless still serve at least in part to position a received connector within receptacle to facilitate a coupling.

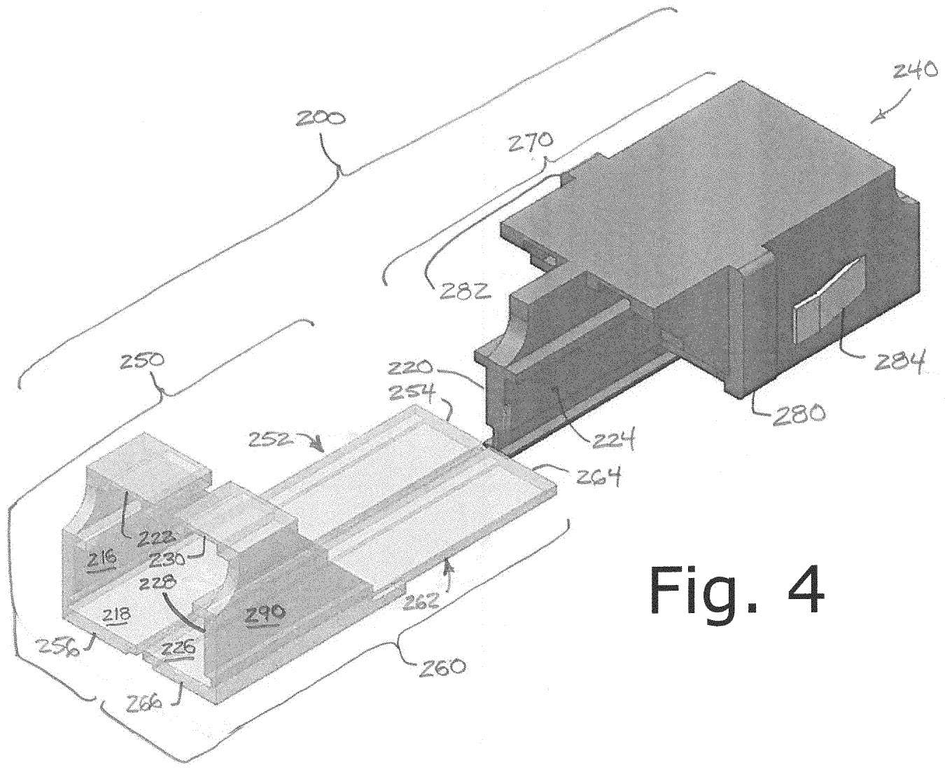

FIG. 4 depicts the same adapter 200 as shown in FIG. 3, except in FIG. 4 it is shown in a partially exploded manner so as to illustrate additional detail of this particular example embodiment. Specifically, adapter 200—which can be formed for example from polymer materials known to those skilled in the art—further comprises two bodies 250 and 260, also referred to herein as body portions 250 and 260, which are mirror images of one another and formed to be sufficiently transparent to a degree that is at least semitransparent, e.g. translucent, if not fully transparent, such that light may passively pass through the material from which body portions 250 and 260 are formed. Separate body portion 270 conversely is formed to be opaque in this particular embodiment. In the fully manufactured adapter 200, body portions 250, 260 and 270 are joined together by methods known to those skilled in the art, for example preferably by either an adhesive or a heat-fusing process, to form one larger body. As a result, body portions 250 and 260 extend, at 252 and 262, along the bottom portion of the fully manufactured and assembled adapter 200. As will be understood with reference to both FIGS. 3 and 4, at least a portion of semitransparent if not transparent body portion 250 of the fully manufactured and assembled adapter 200 is also at least a portion (e.g., interior walls 216 and 218) of the one or more interior walls (e.g., interior walls 216, 218, and opaque wall 220) of the cavity 212, and similarly at least a portion of semitransparent if not transparent body portion 260 is also at least a portion (e.g., interior walls 226 and 228) of the one or more interior walls (e.g., interior walls 226, 228, and opaque wall 224) of the cavity 214.

Depending on the particular design and application for this particular example embodiment, a top portion 222 or 230 of respective body portions 250 or 260 might serve to also help position a received connector, and/or to help retain a received connector within its respective cavity by means of, for example, a deformable connector latch on a connector that engages and cooperates with such top portion 222 or 230.

Importantly, and to ensure clarity, uses of the terms “body” and “body portion” as used throughout this disclosure are not intended to herein set forth new definitions for or ascribe particular limitations to the terms, neither with reference to the example embodiments disclosed herein nor otherwise. Accordingly, except as may be more narrowly specified herein in a particular given context, the term “body” as used herein in the context of a receptacle should at minimum be generally understood to include a given portion, and/or the whole, of either one structure that alone represents, and/or plural structures that together represent, a given portion and/or the whole of the receptacle device, in a traditional sense as is known to those skilled in the art. Moreover, the term “body portion” in the context of a receptacle device as described herein likewise generally should at minimum be understood to include a structural portion of the receptacle, regardless of whether such portion itself comprises a given portion, and/or the whole, of only one structure or plural structures of which a portion and/or the whole of the receptacle devices is comprised. Accordingly, the example embodiments set forth herein shall not operate to limit the scope of the invention to the extent the claims set forth below use the terms “body” and/or “body portion.” The same is true with respect to other terms that may be used in the claims set forth below, such as for example and without limitation the terms “opening,” “cavity,” and “interior wall.”

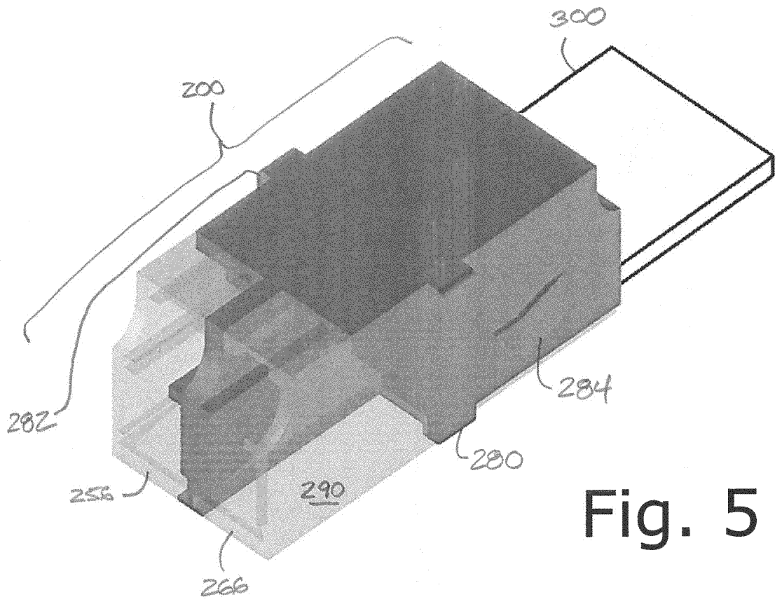

FIGS. 5, 6 and 7 again depict the same optical fiber connector adapter 200 embodiment shown in FIGS. 3 and 4, but now further schematically illustrated together with an adjacent example embodiment combination of a printed circuit board 300 and LEDs 310 and 320 of an example communication system module (not otherwise illustrated) with which adapter 200 may cooperate in the context of a communication system module application. In this example application, adapter 200 is adapted to be retained within an aperture of the module panel 350 as a result of a pressure fit created by flanges 280 and 282 and deformable panel clips or latches 284 and 286, in a manner known to those skilled in the art. In this manner the first, or front, end 210 of example adapter 200 is situated on a first side (sometimes referred to as the system operator side) of the panel 350 of an example communication system module, while the second, or back, end 240 of adapter 200 is situated on the other side of the panel 350 (sometimes referred to in the art as the printed circuit board side). In this illustrated example the system operator side of the panel 350 serves as the side of the illustrated installed adapter 200 through which one or more optical fibers are received so as to be removably coupled by the system installer or system operator to one or more corresponding communication path(s) of the module, for example after such modules are in place in a slot (not shown) of a shelf (not shown) of a communication system (not shown), whereas the other side of the panel 350 is where optical fibers that belong to the module itself for example can be received by adapter 200 through end 240 for example during module manufacture, assembly or installation. Although described as a panel of a communication system module, it will be understood that illustrated structure 350 can instead similarly represent another form of an enclosure of a device for which an embodiment of the adapter of the present invention can serve as a connector adapter of, or point of communication interface with, the device.

In FIGS. 5-7, circuit board 300 represents a portion of an example communication system module that preferably supports and positions LEDs 310 and 320 such that light generated by LED 310 communicates through adapter 200 as described further below. In this example embodiment each of LEDs 310 and 320 could be a single-color LED, but preferably each LED is instead a bi- or multi-color LED such as for example an RGB LED, so as to provide a wider array of illumination color options that can in turn correspond to a wider array of indications the light from the LEDs can convey to for example a system operator.

To this end, one or more LEDs could be controlled independently of one or more other LEDs, or instead or additionally for an even wider array of indications, controlled in combination with control of the other LED(s) so as to allow for the further provision of pairs or sets of color codes wherein for example one pair or set of color codes conveys a different indication to a system operator about the optical port (in this example a two-subsection port) than another pair or set, much like different binary number strings can each represent and convey different information. If/when not controlled together in tandem, each LED 310 and 320 could instead convey information relating to only a respective subsection of the optical port in the example of a two-subsection port application of adapter 200, or relating to only an individual one of two ports of adapter 200 in the example of a single-cavity port application of adapter 200. This same sort of indicator light capability and diversity similarly can find application within the context of other example embodiments of the present invention described herein.

Moreover, instead of or in addition to the color capability described above, LEDs 310 and 320 could be controlled to illuminate in a plurality of other different manners, such as for example different light intensities and/or different static/flash patterns, so as to have the alternative or additional means for conveying a wider variety of information with fewer devices. Once again, this same sort of alternative or additional indicator light diversity, whether illumination intensity and/or pattern, similarly can find application within the context of other example embodiments of the present invention.

In the example embodiment shown in FIGS. 5-7, LED 310 is positioned adjacent the end 264 of body portion 260 so as to allow light generated by LED 310 to communicate at least along a bottom length 262 of body portion 260 from end 264 so as to in turn illuminate at least some portion of body portion 260 that is visible, for example to a system installer or system operator, when the module in which adapter 200 is positioned is situated in an installed position in a communication system. Similarly, LED 320 is positioned adjacent the end 254 (most visible in FIG. 4) of body portion 250 so as to allow light generated by LED 320 to communicate at least along a bottom length 252 of body portion 250 from end 254, so as to in turn illuminate at least some portion of body portion 250 that is visible when the module is in the installed position. In this way, light generated by LED 320 communicates through at least a portion of adapter 200 that serves at least in part as an interior wall portion of the cavity 212—such as for example at least one or both of interior walls 216 and 218, and similarly light generated by LED 310 communicates through at least a portion of adapter 200 that serves at least in part as an interior wall portion of the cavity 214—such as for example at least one or both of interior walls 226 and 228. The example communication system module enables and controls each of LEDs 310 and 320, either individually and/or in tandem, so as to for example provide controlled light representing or signaling (i.e., indicating), for the benefit of an installer, test engineer, or system operator, one or more mode(s), state(s), status, and/or other operational characteristic(s) of the respective port subsections or other communication connection(s) associated with the adapter, or the module within which the adapter is placed, or more generally the communication system to which the module belongs.

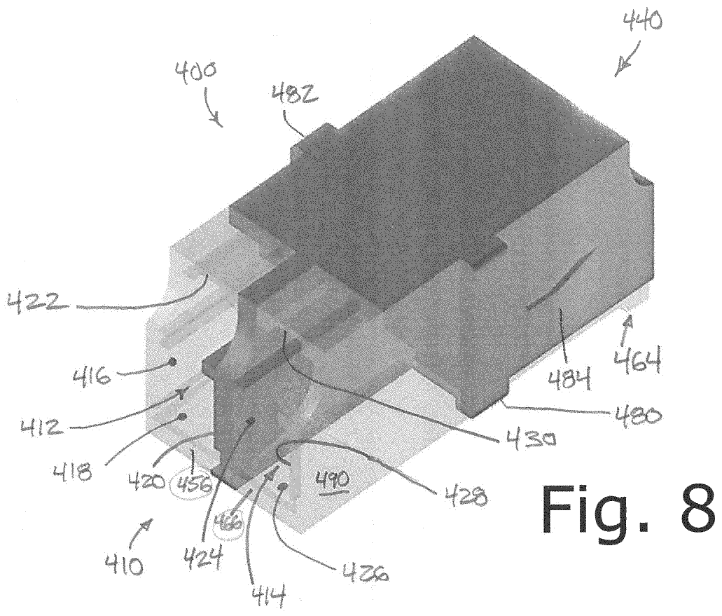

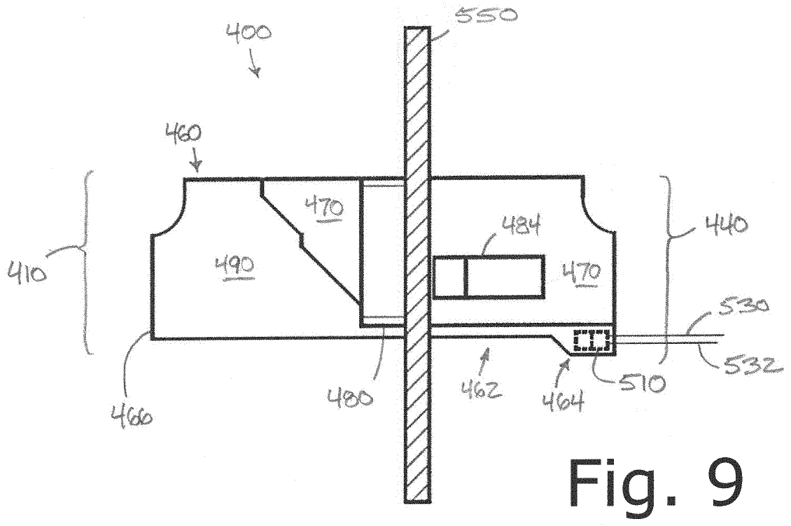

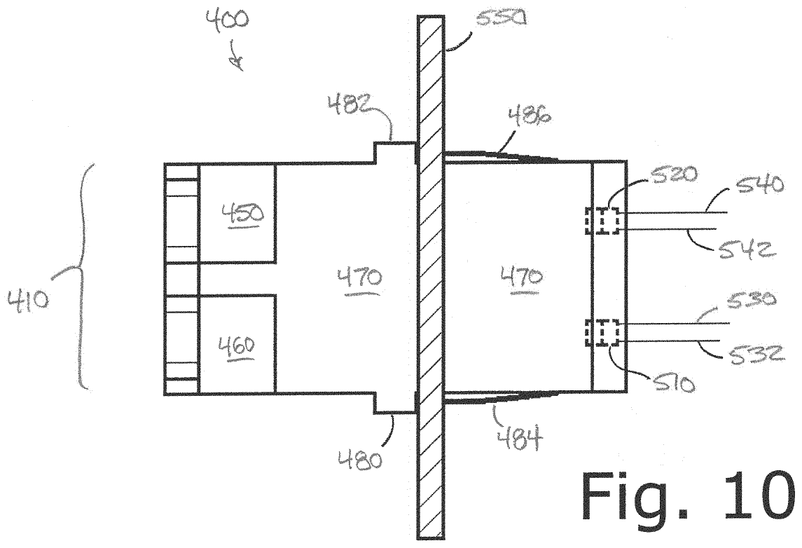

FIGS. 8 and 9 depict another example optical fiber connector adapter embodiment 400 placed, similar to adapter embodiment 200, within a portion of an example panel or enclosure 550. Those skilled in the art will understand and appreciate that adapter 400 is similar if not the same in most respects to adapter 200 embodiment already shown and described. For example, the attributes of adapter 200 associated in FIGS. 3-7 with reference numerals 210, 212, 214, 240, 270 (including without limitation 220, 224, 280, 282, 284 and 286), 250 (including without limitation 216, 218, 222 and 252) and 260 (226, 228, 230 and 262) find direct correspondence to attributes of adapter 400 associated in FIGS. 8, 9 and 10 with reference numerals 410, 412, 414, 440, 470 (including without limitation 420, 424, 480, 482, 484 and 486), 450 (including without limitation 416, 418, 422 and, if it wasn't obscured from view in FIGS. 8, 9 and 10, 452) and 460 (426, 428, 430 and 462), respectively, except as described below.

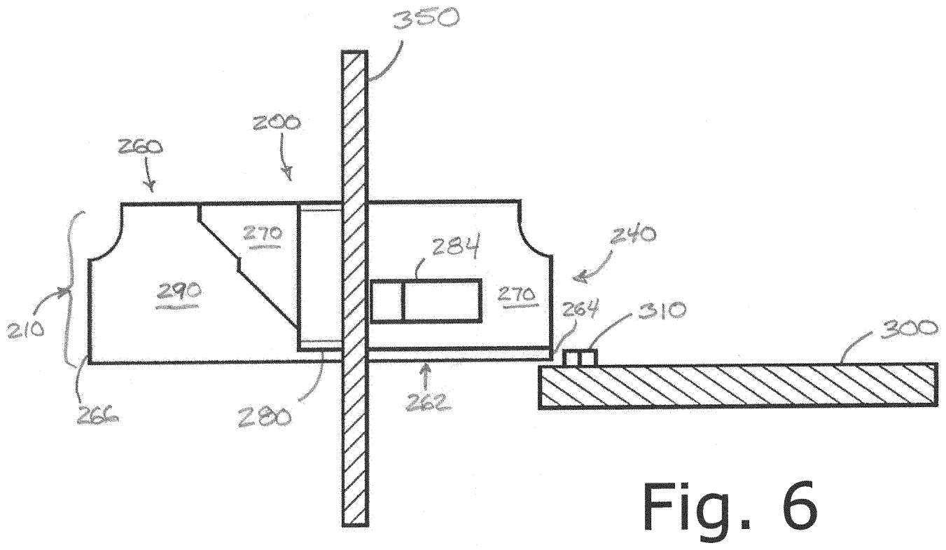

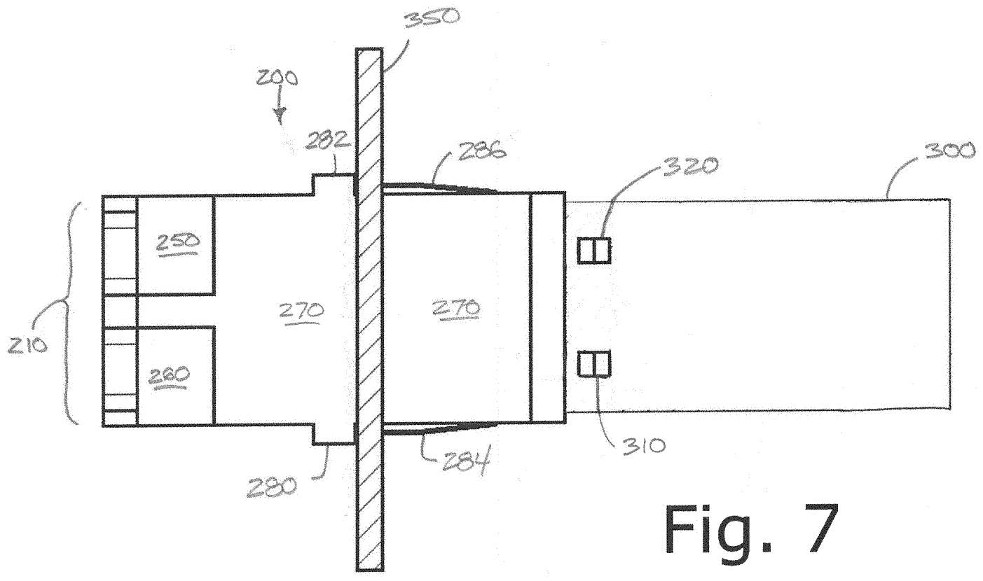

As can be understood by FIGS. 8, 9 and 10, example adapter embodiment 400 comprises two light sources, LEDs 510 and 520, which are located within the adapter 400 and, in this way, are components of the adapter 400 itself, in contrast to the light sources 310 and 320 which are instead situated external to adapter 200 as is most clearly illustrated in FIGS. 6 and 7. More specifically, each of bodies 450 and 460, also referred to herein as body portions 450 and 460, of adapter 400 have an end similar to ends 254 and 264 of body portions 250 and 260, respectively, but in the context of adapter 400 each of these ends are instead modified to include a light source, LEDs 520 and 510 respectively, within the end portion. One such end 464 is depicted and visible in the side view set forth in FIG. 9. It will be understood that body portion 450 includes an end (not labeled in the figures) similar to end 464 of body portion 460. One or more electrical connections 530 and 532 for example can be made between adapter 400 and the module in which it is placed, so as to allow for control of LED 510 from external to the body portion 460, and indeed external to adapter 400, by for example the module. Similarly, one or more electrical connections 540 and 542 can be made so as to allow for control of LED 520 from external to the body portion 450, and indeed external to adapter 400.

In a similar manner as described above, in this example embodiment light generated by LED 510 can communicate at least along a bottom length 462 of body portion 460 from end 464 so as to in turn illuminate at least some portion of body portion 460 that is visible, for example to a system installer or system operator, when the module in which the adapter 400 is positioned is situated in an installed position in a communication system. Similarly, light generated by LED 520 can communicate at least along a corresponding bottom length of body portion 450 so as to in turn illuminate at least some portion of body portion 450 that is visible when the module is in the installed position. In this way, light generated by LED 520 communicates through at least a portion of the adapter 400 that serves at least in part as an interior wall portion of the cavity 412—such as for example at least one or both of interior walls 416 and 418, and similarly light generated by LED 510 communicates through at least a portion of the adapter 400 that serves at least in part as an interior wall portion of the cavity 414—such as for example at least one or both of interior walls 416 and 418. The example communication system module enables and controls each of LEDs 510 and 520, either individually and/or in tandem, so as to for example provide light representing or signaling (i.e., indicating), for the benefit of an installer, test engineer, or system operator, one or more mode(s), state(s), status, and/or other operational characteristic(s) of the respective port subsections or other communication connection(s) associated with the adapter, or the module within which the adapter is placed, or more generally the communication system to which the module belongs.

Example adapter embodiments 200 and 400 can each illuminate to the extent necessary or desired to provide mode/state/status/operational information about the corresponding port subsections or other communication connection(s) that the respective adapter serves to establish. For a given application, these adapters can be used in a manner whereby they illuminate in one or a plurality of different manners, such as for example different colors, different light intensities, and/or different static/flash patterns, so as to have the capacity to convey a variety of information using only the adapter itself. Moreover, because it is the adapter itself that is capable of illuminating in this way, the present invention can for example in certain applications provide for a more streamlined, efficient, and/or effective use of any limited surface area that may otherwise be available on a panel of a communication system module.

Now with parallel reference to each of example adapters 200 and 400, these adapters are each adapted to receive up to two optical fiber connectors on the respective front end 210, 410 of the adapter, for example a connector pair not unlike connector pair 120 illustrated in FIG. 2. The adapters also receive up to two optical fiber connectors on the respective back end 240, 440 of the adapter, such that the adapter serves to align and optically couple, on one hand, the optical fiber or optical fiber pair associated with the connector(s) received on the front end 210, 410 of the respective adapter with, on the other hand, the optical fiber or optical fiber pair associated with the connector(s) received on the back end 240, 440 of the respective adapter.

More specifically, a given one optical fiber connector is removably received through one of the two openings in a front end of the example adapter and into a cavity defined at least in part by one or more interior walls that extend into the adapter from the opening. The adapter comprises a body portion, wherein a first surface of the body portion is at least a portion of a surface of the one or more interior walls of the cavity. At least a portion of the body portion is at least semitransparent if not transparent, including in particular at least a portion that is also at least a portion of one or more of the interior walls that define the cavity. To the extent the body portion, including for example and without limitation the first surface, is at least semitransparent if not transparent, the example adapter is adapted for example to communicate, through the first surface and into the cavity, light generated by an adjacent external or integrated internal LED that passes through the body portion. As a result, when this example adapter is placed in a communication system module panel, or another device enclosure, the adapter can be viewed from the operator side of the panel or enclosure as illuminating at least in part from within the cavity that is accessible on the operator side.

Alternatively or additionally, to the extent the body portion is at least semitransparent if not transparent, including for example and without limitation a second surface of the body portion that is at least a portion of an exterior surface of the example adapter, the adapter is adapted for example to communicate, out the second surface, light generated by the LED (whether that LED is located adjacent the adapter or integrated internal to the adapter, as both are described above) that passes through the body portion. Such second surface can be for example at least a portion of a front-end surface of the adapter immediately adjacent the opening, or it can be for example another exterior surface of the adapter. Of course, it will also be understood by those skilled in the art that the scope of the invention also includes without limitation embodiments whereby more than just one exterior surface of the adapter illuminates. With respect to example adapter embodiments 200 and 400, preferably the entirety of body portions 250, 260, 450 and 460 are capable of illuminating.

By way of further illustration, with respect to adapter 200 light generated by LED 310 enters body portion 260 at end 264 and passes through bottom length 262 of body portion 260, and thereafter illuminates at least a portion of adapter 200 that extends on the operator side (e.g., left-hand side, in FIGS. 6-7) of panel 350. More specifically, after communicating through the body portion 260 the LED light communicates out of at least adapter exterior surface 266 on the front face, or front exterior surface, of adapter 200 at the front end 210 of adapter 200. Exterior surface 266 of fully assembled adapter 200 lies at least in part in a same plane, whether a full plane or instead just a plane portion, as the opening to cavity 214 at the front end 210 of adapter 200, and also lies immediately adjacent as the opening to cavity 214. The LED light communicating through the body portion 260 can also communicate for example out of exterior surface 290 on the side of adapter 200, which lies on a different plane than the plane in which the opening to cavity 214 lies, and preferably the light in this example embodiment communicates out of all of the at least multiple if not all exterior surfaces of body portion 260 so as to illuminate the entirety of body portion 260. If desired, even the adapter cavities might also be illuminated in this way by the illumination of body portion 260.

In a similar manner light generated by LED 320 separately communicates through body portion 250 and out of at least adapter exterior surface 256, while in the context of adapter 400, light generated by LED 510 communicates through a bottom length 462 of body portion 460 and out of at least adapter exterior surface 466, and light generated by LED 520 communicates through a bottom length of body portion 450 and out of at least adapter exterior surface 456. Light may also exit, and thus illuminate, other exterior surfaces of these adapters, including other outer surfaces of the body portions 250, 260, 450 and 460 that are exterior surfaces of the respective adapters. By illuminating example adapter 200 in this way using multiple exterior surfaces, including for example surfaces that lie at least in part in different planes from one another, can serve to allow the illumination of the adapter to be more readily viewed from multiple angles of perspective. Further, as noted above, if desired the adapter cavities might also be illuminated in this way by the illumination of body portions 250, 260, 450 and 460. Moreover, the two body portions 250 and 260 as disposed within fully assembled example adapter 200 are separated by an opaque portion of adapter 200, and more specifically, that portion of body portion 270 that establishes walls 220 and 224. As a result of the isolation thus created by this opaque portion of body portion 270, the light that passes through the body portion 260 does so without a substantial amount of such light passing into body portion 250. Similarly, the light that passes through the body portion 250 does so without a substantial amount of such light passing into body portion 260. A similar isolation is present in adapter 400, as a result of opaque body portion 470 situated between body portions 450 and 460.

With respect to further example embodiments and applications, the light from an LED that causes adapter 200, as well as the other example embodiment receptacles described herein, to illuminate can be a first color in a first state of operation of the associated port, port subsection, connection, module, and/or system, and a second color in a second state of operation of the port, port subsection, connection, module, and/or system, so as to indicate to a system installer, tester and/or operator for example, the current state of the port, module, and/or system. The light can operate to distinguish one communication port, port subsection, and/or other connection from another one or more port(s), port subsection(s), and/or other connection(s), whether on the same pluggable, module, or elsewhere. The light can operate to provide an indication relating to at least one of identification, enablement, disablement, status, capability, commissioning, and debugging, of the associated optical communication port, module, and/or system.

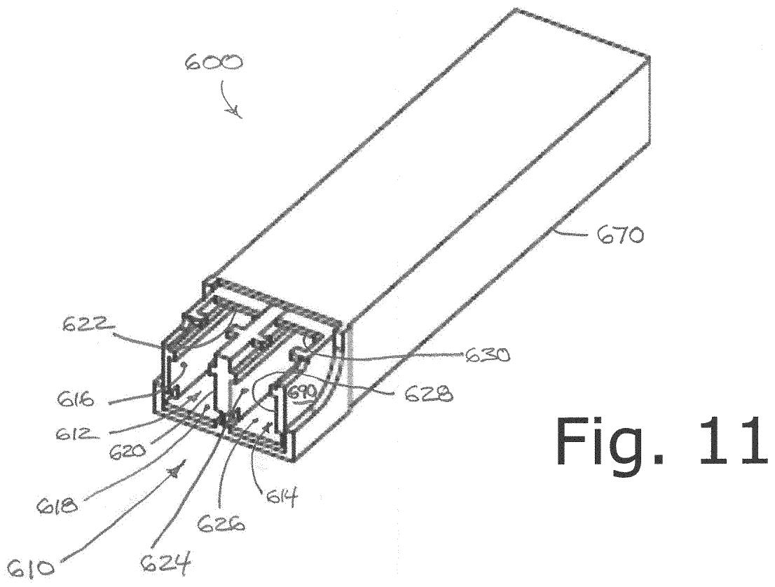

Another example embodiment of the present invention is illustrated schematically beginning with FIG. 11. The kind of receptacle in this particular example is a small form-factor pluggable (SFP), such as an SFP optical transceiver for example, although as previously indicated the present invention generally speaking is not for example limited to adapters and pluggables, nor to these particular form factors of adapters and pluggables, nor to any one or more particular form factor of receptacle, nor to form factors that are industry standardized. That said, various examples of the different kinds of pluggable form factors for which the present invention could find similar application in the context of industry-standard form-factor pluggables (herein generically and short-handedly referred to as FPs in the plural form, or FP in the singular form) include, without limitation, SFP, QSFP (Quad Small Form-Factor Pluggable), CFP2, CFP4, and CFP8. Those skilled in the art will recognize that other industry-standard form-factors for pluggables can similarly fall within the scope of the term FP.

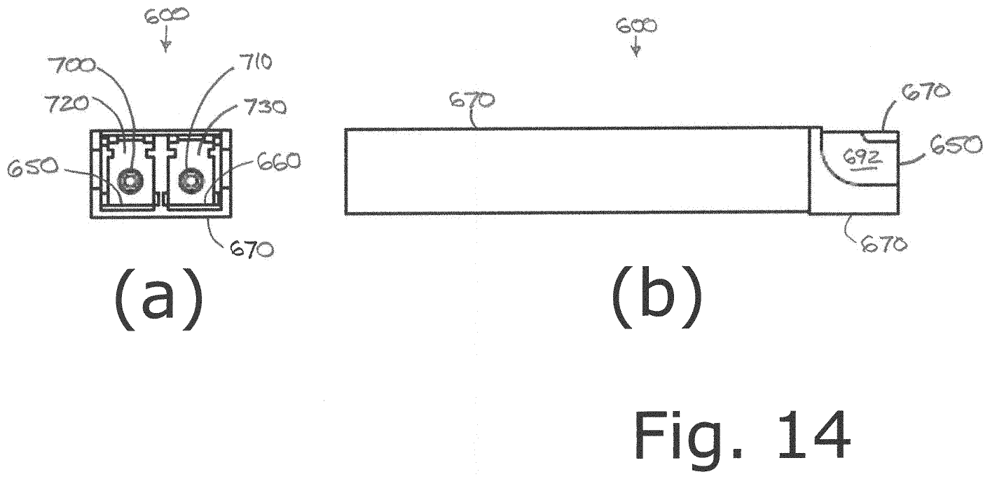

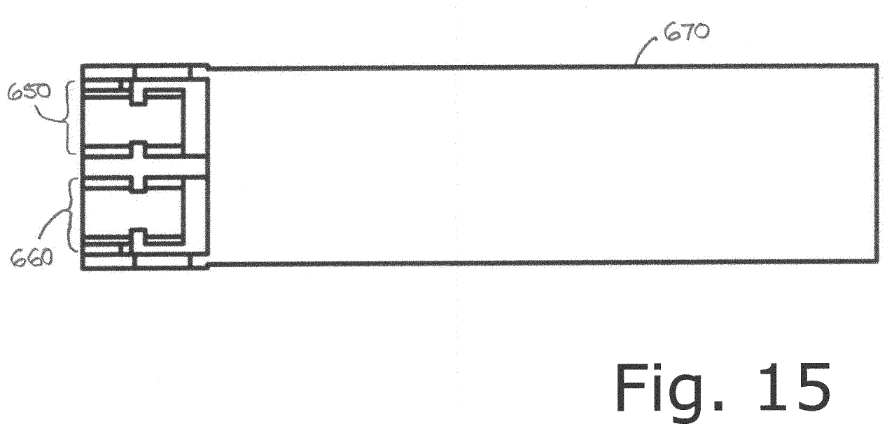

Referring now again to the additional embodiment illustrated in FIGS. 11-15, therein depicted is SFP 600 which is a compact, hot-pluggable optical module transceiver that could be used for example in telecommunication and/or data communications. This particular example SFP 600 is adapted to be inserted into a corresponding slot of a larger module or card or device, and SFP 600 has a first, or front, end 610 that is adapted to receive one or more optical fiber connectors from a system operator side of the SFP as do for example more conventional SFPs and other FPs of the sort already known to those of skill in the art. SFP 600 can serve as a point of interface on for example a front panel of a module of a communication system and, in this way, SFP 600 could be used for example to support both the transmit (Tx) and receive (Rx) subsections of an optical communication port wherein the Tx subsection is associated with a first cavity of the two cavities 212 and 214 while the Rx subsection is associated with the other of the two cavities 212 and 214.

In this regard, in this particular example embodiment an optical fiber connector can be received through an opening in the first end 210 of the SFP 600 and into a cavity, such as for example one of cavities 212 and 214. SFP 600 for example could support an optical communication port wherein cavities 612 and 614 each relate to a respective subsection (either transmit or receive) of the optical communication port. Each cavity 612 and 614 is defined at least in part by one or more interior walls that extend into the adapter from the opening, such as for example at least walls 616, 618 and 620 of cavity 612, and at least walls 624, 626 and 628 of cavity 614, and serve at least in part to position a received connector within receptacle to facilitate a coupling with one or more communication paths, and in the example of SFP 600, more specifically an optical coupling with and between the SFP 600 and an optical fiber terminated by the received optical fiber connector. In this example, a given optical fiber connector is received into cavity 612 or 614 through one of the two openings in an exterior surface at the first, or front, end 610 of SFP 600, the opening being formed at least in part by and along the exterior edges of at least walls 616, 618 and 620, in the case of the opening associated with cavity 612, or the exterior edges of at least walls 624, 626 and 628, in the case of the opening associated with cavity 614. Depending on the particular design and application, a top portion 622 or 630 of respective bodies 650 or 660, also referred to herein as body portions 650 or 660, in this particular example embodiment might serve to also help position a received connector, and/or to help retain a received connector within its respective cavity by means of, for example, a deformable connector latch of a connector that engages and cooperates with such top portion 622 or 630.

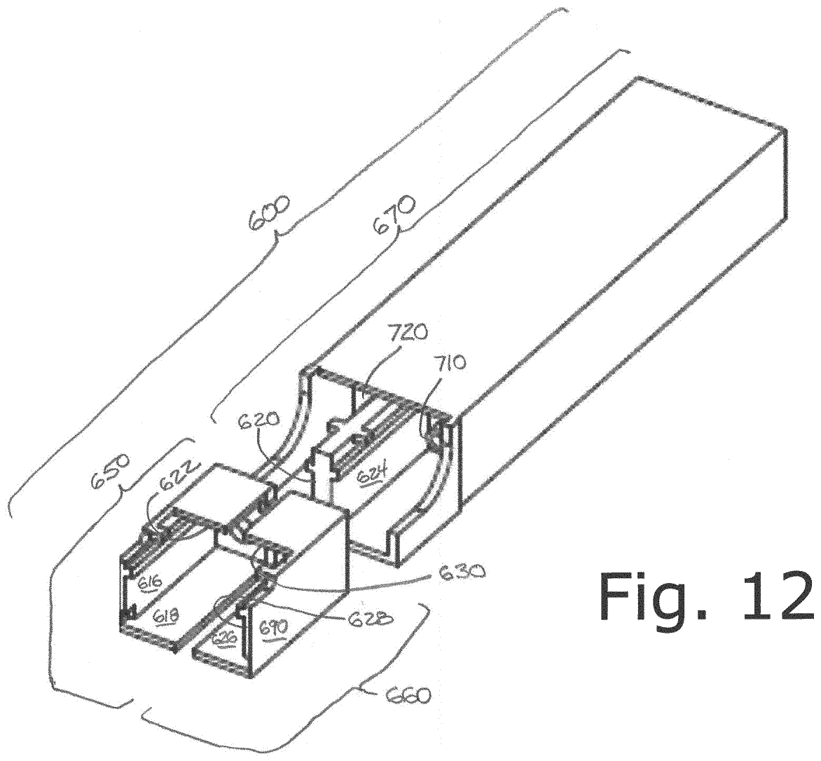

FIG. 12 depicts the same SFP 600 as shown in FIG. 11, except in FIG. 12 it is shown in a partially exploded manner so as to illustrate additional detail of this particular example embodiment. Specifically, the SFP 600 further comprises two body portions 650 and 660, which are mirror images of one another and formed to be at least semitransparent if not transparent such that light may pass through the material from which body portions 650 and 660 are formed. Those skilled in the art however will recognize that SFP 600 could alternatively comprise one semitransparent if not transparent body portion that spans to include both cavities, for example wherein body portions 650 and 660 are instead formed and connected together as one unitary piece Like the other embodiments described herein, SFP 600 illustrates but just one example embodiment. Accordingly, those skilled in the art however will recognize that other example embodiments of SFPs, and more generally other example embodiments of receptacles, are possible without departing from the spirit and scope of the present invention.

Returning to the illustrated example SFP 600, the exterior of illustrated body portion 670 conversely is formed to be generally opaque, with the exception for example of the optical path end at each of optical connection locations 710 and 720 as well as, as will be described further below, the sources of light to supply light for passive communication through body portions 650 and 660. As will be understood with reference to both FIGS. 11 and 12, at least a portion of semitransparent if not transparent body portion 650 of the fully manufactured and assembled SFP 600 is also at least a portion (e.g., interior walls 616 and 618) of the one or more interior walls (e.g., interior walls 616, 618, and opaque wall 620) of the cavity 612, and similarly at least a portion of semitransparent if not transparent body portion 660 is also at least a portion (e.g., interior walls 626 and 628) of the one or more interior walls (e.g., interior walls 626, 628, and opaque wall 624) of the cavity 614.

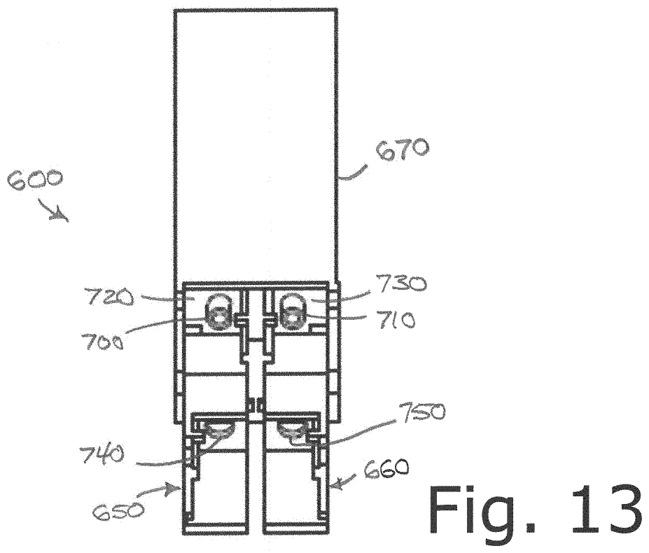

Each of FIGS. 13, 14 and 15 again depict the same SFP 600 embodiment shown in FIGS. 11 and 12, but now in alternate view or perspective. Obscured from these particular illustrations is a second, or back, end of this example SFP 600, namely the same end that in conventional pluggables typically first enters the slot when the pluggable is put in place for operation. It will be understood that although not shown, this example embodiment SFP 600 has at least electrical connections on its back end sufficient to support the conventional functionality of the pluggable, which is an optical transceiver in this illustration. Alternative examples of pluggables include without limitation pluggables that are an optical transponder, and pluggables that are one of an optical receiver or optical transmitter. Among these or in addition to these connections, the back end of SFP 600 has electrical connection(s) sufficient so as to allow for control of one or more LED(s) or other light source(s) internal to SFP 600, and more specifically for example one or more light source(s) associated with body portion 670 such as for example located inside body portion 670, from external to SFP 600 if control external from the SFP 600 is desired. Such light source(s) can be controlled so as to produce light that for example is delivered, either directly or indirectly, into the respective body portions 650 and 660 at the respective locations where body portion 650 interfaces inner wall 720 and body portion 660 interfaces inner wall 730. Alternatively the light sources could be located external to the pluggable, whereby such externally generated light is instead delivered through one or more light pipes that each extend as a component of the pluggable, for example extending as part of body portion 670 to one of inner walls 720 and 730, so as to pass light to and illuminate at least a portion of the pluggable that is preferably viewable from an operator perspective, such as for example one of semitransparent if not transparent body portion 650 and 660.

Apertures 740 and 750 respectively in each of body portion 650 and 660 allow the optical path end at each of optical connection locations 700 and 710 to directly couple with the optical fiber of the received connector. The opaqueness of interior walls 620 and 624 situated between body portions 650 and 660 provides optical isolation between body portions 650 and 660, similar to that which is discussed above in connection with body portions 250 and 260 of adapter 200 and body portions 450 and 460 of adapter 400. For further disclosure concerning the characteristics and control of such LED(s) or other light source(s), as well as the various forms light and corresponding conveyed indications that are possible as a result, the above description relative to LEDs of the adapter 200 and 400 embodiments is similarly applicable to the SFP 600 embodiment.

By way of further illustration, with respect to SFP 600, light generated by one or more LED(s) (not illustrated) within body portion 670, or instead delivered for example by light pipes as also described above, enters body portion 660 where body portion 660 meets inner wall 730 and passively communicates through body portion 660, and thereafter illuminates at least a portion of SFP 600 that is preferably viewable from the perspective of an operator looking at front end 610. More specifically, after communicating through the body portion 660 the LED light communicates out of at least one preferably more than one of the exterior surfaces of the SFP 600 so as to illuminate the exterior of body portion 660. Moreover, the light could instead or additionally communicate out of one or more of interior walls, such as interior walls 626 and 628 for example, into cavity 614. Body portion 650 can separately communicate light and illuminate in a similar fashion, as those skilled in the art will appreciate from the disclosure and figures herein.

While this invention has been particularly shown and described with references to example embodiments thereof, it will be understood by those skilled in the art that various changes in form and details may be made therein without departing from the scope of the invention encompassed by the claims set forth below. For example and without limitation, each of the example embodiments of the invention illustrated herein are depicted as having dual cavities, or in other words two side-by-side cavities, that extend from a given end of the illustrated embodiment, which for example can be suitable for an optical port application in which a given receptacle is adapted with two port subsections together capable of receiving two optical fiber connectors from the same operator side of the receptacle, wherein one of the two connectors relates to a transmit (Tx) fiber for a Tx subsection of the port while the other of the two connectors relates to a receive (Rx) fiber for a Rx subsection of the port. Nevertheless, with the benefit of the figures and other disclosure provided herein it will be understood by those skilled in the art that the present invention is not limited to optical applications, nor does the present invention necessarily require dual cavities, insofar as the apparatus and method of the present invention may instead relate for example to a receptacle adapted for electrical rather than optical coupling, and/or may instead for example employ only one cavity or more than two cavities on a given end of the receptacle.

In summary, and without limiting the scope of the invention, one or more of the foregoing example embodiments illustrate an optical fiber connector receptacle comprising one or more walls that define an interior cavity of the optical fiber connector receptacle, a body shaped to establish at least a portion of at least one of the one or more walls, wherein an end of the interior cavity comprises an opening that provides access to the interior cavity from external to the optical fiber connector receptacle, and wherein the interior cavity is adapted to receive an optical fiber connector inserted into the interior cavity through the opening, and wherein the one or more walls that define the interior cavity are adapted to position within the interior cavity the received optical fiber connector to enable optical coupling of an optical fiber terminated by the received optical fiber connector, and wherein the body comprises a surface through which the body is adapted to emit at least one wavelength of visible light that passes through at least a portion of the body to the surface.

In each of these one or more example embodiments, the at least a portion of the body, if not the entirety of the body, is semitransparent or transparent so as to pass visible light, while one or more other components of at least certain ones of these example embodiments may be opaque. An opaque component, such as for example the respective component that establishes each of walls 220, 420, and/or 620 in certain of the example embodiments herein, can serve to provide a certain degree of optical isolation between a first body and a second body of the same receptacle, such as for example respectively first body 250 and second body 260, and/or first body 450 and second body 460, and/or first body 650 and second body 660, illustrated herein and described above in connection with the Figures. It will be understood to those skilled in the art, however, that the receptacle of the present invention need not be necessarily constructed from, or otherwise comprise, multiple components.

Referring back to the first body 250 and second body 260, and first body 450 and second body 460, and first body 650 and second body 660, illustrated herein and described above in connection with the Figures in the context of the respective embodiment in which each of these respective first body and second body pairs are shown and described, it is apparent in each of these example embodiments that each of these bodies serves, among other things, to define at least a portion, and as illustrated indeed as much as at least a majority, of the opening of the internal cavity with which the body is associated.

As is also demonstrated by one or more example embodiments herein, at least a portion of the surface, through which the body is adapted to emit at least one wavelength of visible light that passes through at least a portion of the body to the surface, can be for example: an interior cavity surface of at least one of the one or more walls that define the interior cavity (such as, for example and without limitation, at least each of walls 218, 226, 418, 426, 618, and 626); and/or a surface that lies outside the interior cavity—for example and without limitation, a surface outside the interior cavity associated with the body under consideration adjacent the opening of such interior cavity (such as, for example and without limitation, at least each of surfaces 256, 266, 456, and 466). The foregoing surface outside the interior cavity adjacent the opening can lie in at least substantially the same plane as a plane in which the opening lies.

One or more example embodiments herein also demonstrate an optical fiber connector receptacle that is a component of a communication system device comprising at least one optical port, wherein the at least one wavelength of visible light for example: has a first characteristic in a first state of the optical port and a second characteristic in a second state of the optical port; and/or has a first set of one or more characteristics in a first state of the communication system device, and in a second state of the communication system device, a second set of one or more characteristics that differs at least in part from the first set of one or more characteristics; and/or is visible light generated by the communication system device in a first state of the communication system device that is not generated by the communication system device in a second state of the communication system device; and/or is visible light generated by the communication system device to distinguish one optical port from another optical port; and/or is indicative of at least one operational attribute of the communication system device. Each of the above-described first and/or second states of the communication system device can relate, but need not necessarily relate, to one or more states of an optical port of the communication system device.

The communication system device of the sort described above can be, for example, a communication system module. Such a communication system device can instead be by way of illustration a pluggable communication system device, such as for example a pluggable optical transceiver, or pluggable optical transponder, or pluggable optical receiver, or pluggable optical transmitter, including without limitation FP versions of the foregoing.

As described above, certain one or more of the example embodiments set forth herein contemplate a light source that is integrated within the body and an electrical connection that extends at least through at least a portion of the body between the light source and a surface of the body, so as to enable illumination control of the light source from external to the optical fiber connector receptacle, while other of the example embodiments instead contemplate a light source that is at least external to the body, if not altogether external to the receptacle. In the example embodiments shown and described above, light from a light source that is external to the receptacle enters the semitransparent or transparent body through one surface of the body and is emitted through another surface of the body after passing through the body.

What is claimed is:

1. An optical fiber connector receptacle, comprising:
one or more walls that define an interior cavity of the optical fiber connector receptacle;
a body shaped to establish at least a portion of at least one of the one or more walls;
wherein an end of the interior cavity comprises an opening that provides access to the interior cavity from external to the optical fiber connector receptacle;
wherein the interior cavity is adapted to receive an optical fiber connector inserted into the interior cavity through the opening;
wherein the one or more walls that define the interior cavity are adapted to position within the interior cavity the received optical fiber connector to enable optical coupling of an optical fiber terminated by the received optical fiber connector; and
wherein the body comprises a surface through which the body is adapted to emit at least one wavelength of visible light that passes through at least a portion of the body to the surface.

2. The optical fiber connector receptacle of claim 1, wherein the at least a portion of the body is translucent.

3. The optical fiber connector receptacle of claim 1, wherein the at least a portion of the body is transparent.

4. The optical fiber connector receptacle of claim 1, wherein an entirety of the body is transparent to a degree selected from a group consisting of semitransparent and transparent.

5. The optical fiber connector receptacle of claim 4, wherein in addition to the body the optical fiber connector receptacle comprises at least a component that is opaque at least in part.

6. The optical fiber connector receptacle of claim 5, wherein the opening is defined at least in majority part by the body.

7. The optical fiber connector receptacle of claim 1, wherein the surface of the body comprises an interior cavity surface of at least one of the one or more walls that define the interior cavity.

8. The optical fiber connector receptacle of claim 1, wherein at least a portion of the surface lies outside the interior cavity adjacent to the opening.

9. The optical fiber connector receptacle of claim 1:
wherein the optical fiber connector receptacle is a component of a communication system device comprising at least one optical port;
wherein the at least one wavelength of visible light has a first characteristic in a first state of the optical port; and
wherein the at least one wavelength of visible light has a second characteristic in a second state of the optical port.

10. The optical fiber connector receptacle of claim 1, wherein the optical fiber connector receptacle is an optical fiber connector adapter.

11. The optical fiber connector receptacle of claim 1, wherein the at least one wavelength of visible light comprises light from a light source external to the optical fiber connector receptacle that is introduced into the optical fiber connector receptacle through another surface of the body.

12. The optical fiber connector receptacle of claim 1, further comprising:
a light source;
an electrical connection adapted to enable illumination control of the light source from external to the optical fiber connector receptacle; and
wherein the at least one wavelength of visible light comprises light that the light source is adapted to generate.

13. The optical fiber connector receptacle of claim 12, wherein the light source is integrated within the body and the electrical connection extends at least through at least a portion of the body between the light source and a surface of the body.

14. The optical fiber connector receptacle of claim 1, wherein the optical fiber connector receptacle is adapted to be affixed in an aperture of a front panel of a communication system module.

15. The optical fiber connector receptacle of claim 1:
wherein the optical fiber connector receptacle is a component of a communication system device comprising at least one optical port;
wherein the communication system device is selected from a group consisting of a communication system module and a pluggable communication system device;
wherein the at least one wavelength of visible light has a first set of one or more characteristics in a first state of the communication system device; and
wherein the at least one wavelength of visible light has, in a second state of the communication system device, a second set of one or more characteristics that differs at least in part from the first set of one or more characteristics.

16. The optical fiber connector receptacle of claim 1:
wherein the optical fiber connector receptacle is a component of a communication system device comprising at least one optical port;
wherein the communication system device is selected from a group consisting of a communication system module and a pluggable communication system device; and
wherein the at least one wavelength of visible light is visible light generated by the communication system device in a first state of the communication system device that is not generated by the communication system device in a second state of the communication system device.

17. The optical fiber connector receptacle of claim 1:
wherein the optical fiber connector receptacle is a component of a communication system device;
wherein the communication system device is selected from a group consisting of a communication system module and a pluggable communication system device;
wherein the communication system device comprises a plurality of optical ports at least one of which is is established at least in part by the optical fiber connector receptacle; and
wherein the at least one wavelength of visible light is visible light generated by the communication system device to distinguish one of the plurality of optical ports from another of the plurality of optical ports.

18. An optical fiber connector receptacle, comprising:
one or more walls that define an interior cavity of the optical fiber connector receptacle;
a body shaped to establish at least a portion of at least one of the one or more walls;
wherein an end of the interior cavity comprises an opening that provides access to the interior cavity from external to the optical fiber connector receptacle;
wherein the interior cavity is adapted to receive an optical fiber connector inserted into the interior cavity through the opening;
wherein the one or more walls that define the interior cavity are adapted to position within the interior cavity the received optical fiber connector to enable optical coupling of an optical fiber terminated by the received optical fiber connector;
wherein the body comprises a surface through which the body is adapted to emit at least one wavelength of visible light that passes through at least a portion of the body to the surface; and
wherein the optical fiber connector receptacle is a component of a communication system device selected from a group consisting of a communication system module and a pluggable communication system device;
wherein the at least one wavelength of visible light is indicative of at least one operational attribute of the communication system device.

19. The optical fiber connector receptacle of claim 18;
wherein the opening lies substantially in a first plane at an end of the optical fiber connector receptacle; and
wherein at least a portion of the surface lies both outside the interior cavity adjacent to the opening and at least substantially in the first plane.

20. An optical fiber connector receptacle, comprising:
one or more walls that define a first interior cavity of the optical fiber connector receptacle;
a first body shaped to establish at least a portion of at least one of the one or more walls;
wherein an end of the first interior cavity comprises a first opening that is defined at least in part by the first body and provides access to the first interior cavity from external to the optical fiber connector receptacle;
wherein the first interior cavity is adapted to removably receive a Form-Factor Pluggable (FP) optical fiber connector inserted into the first interior cavity through the first opening;
wherein the one or more walls that define the first interior cavity are adapted to position within the first interior cavity a FP optical fiber connector to enable optical coupling of an optical fiber terminated by the FP optical fiber connector received into the first interior cavity; and
wherein the first body comprises a surface through which the first body is adapted to emit at least one wavelength of visible light that passes through at least a portion of the first body to the surface of the first body.

21. The optical fiber connector receptacle of claim 20, wherein the optical fiber connector receptacle is a component of a pluggable communication system device selected from a group consisting of a pluggable optical transceiver, a pluggable optical transponder, a pluggable optical receiver, and a pluggable optical transmitter.

22. The optical fiber connector receptacle of claim 20;
wherein the first opening lies substantially in a first plane at an end of the optical fiber connector receptacle; and
wherein at least a portion of the surface of the first body lies both outside the first interior cavity adjacent to the first opening and at least substantially in the first plane.

23. The optical fiber connector receptacle of claim 20, wherein the optical fiber connector receptacle further comprises:
one or more walls that define a second interior cavity of the optical fiber connector receptacle;
a second body shaped to establish at least a portion of at least one of the one or more walls that define the second interior cavity;
wherein an end of the second interior cavity comprises a second opening that is defined at least in part by the second body and provides access to the second interior cavity from external to the optical fiber connector receptacle;
wherein the second interior cavity is adapted to removably receive a FP optical fiber connector inserted into the second interior cavity through the second opening;
wherein the one or more walls that define the second interior cavity are adapted to position within the second interior cavity a FP optical fiber connector to enable optical coupling of an optical fiber terminated by the FP optical fiber connector received into the second interior cavity; and
wherein the second body comprises a surface through which the second body is adapted to emit at least one wavelength of visible light that passes through at least a portion of the second body to the surface of the second body; and
wherein the first body and second body are sufficiently optically isolated from each other within the optical fiber connector receptacle so as prevent at least a substantial amount of visible light from passing between the second body portion and the first body portion.
